(19) United States
(12) Patent Application Publication
(10) Pub. No.: US 2015/0161093 A1
(43) Pub. Date: Jun. 11, 2015

(54) EVENT PAYLOAD TYPE CHECKING

(71) Applicant: Google Inc., Mountain View, CA (US)

(72) Inventor: Malte Ubl, San Francisco, CA (US)

(73) Assignee: Google Inc., Mountain View, CA (US)

(21) Appl. No.: 14/101,310

(22) Filed: Dec. 9, 2013

(51) Int. Cl. G06F 17/24

(52) U.S. Cl. CPC G06F 17/241

(57) ABSTRACT

Systems, methods and computer readable media for user event payload type checking are disclosed. In some implementations, the method can include receiving a hierarchy of nodes, and associating an annotation element with one or more nodes, the annotation element corresponding to an event of a first type. The method can also include determining a second type based on a declaration of the event, and creating payloads of the second type corresponding to the event. The method can further include performing type checking on event and corresponding payloads.

### FIELD

Some implementations relate generally to user interface frameworks and, more particularly, to methods, systems and computer readable media for event payload type checking.

### BACKGROUND

Some user interface (UI) models include, and may require, the use of UI software components for both rendering the UI and handling user interaction with the UI. Also, in some UI models, software components associated with the UI may be created and initialized at load time (e.g., at the load time of a web page), which may cause the page to load slowly and use memory for components that may not be needed when the page first loads (or may not be needed at all) depending on user interaction with the UI. Further, some UI models may require code to set up elements, create objects and listen for events. Such code can increase the page size of files, reduce the readability of the page source code (e.g., HTML) and may increase the load time of a page having code.

In some UI frameworks, events may be represented as strings to facilitate late binding. However, events may often be accompanied by a payload and it may be desirable to type check payloads expressed as strings.

### SUMMARY

Some implementations can include a method. In some implementations, the method can include receiving a document having a hierarchy of nodes, and associating an annotation element with one or more nodes, the annotation element corresponding to an event of a first type. The method can also include determining a second type based on a declaration of the event, and creating payloads of the second type corresponding to the event. The method can further include performing type checking on event and corresponding payloads.

The declaration of the event can include an event name and payload type to be associated with the event. The event can include a first class communicating with a second class. In some implementations, performing type checking can include performing compile-time type checking. In some implementations, performing type checking can include performing run-time type checking.

The method can also include establishing a binding between an event type and a payload type. The events and payloads can be represented as strings.

Some implementations can include a system having one or more processors configured to perform operations. The operations can include receiving a document having a hierarchy of nodes, and associating an annotation element with one or more nodes, the annotation element corresponding to an event of a first type. The operations can also include determining a second type based on a declaration of the event, and creating payloads of the second type corresponding to the event. The operations can further include performing type checking on event and corresponding payloads.

The declaration of the event can include an event name and payload type to be associated with the event. The event can include a first class communicating with a second class. In some implementations, performing type checking can include performing compile-time type checking. In some implementations, performing type checking can include performing run-time type checking

The operations can also include establishing a binding between an event type and a payload type. The events and payloads can be represented as strings.

Some implementations can include a nontransitory computer readable medium having software instructions stored thereon that, when executed by a processor, cause the processor to perform operations. The operations can include receiving a document having a hierarchy of nodes, and associating an annotation element with one or more nodes, the annotation element corresponding to an event of a first type. The operations can also include determining a second type based on a declaration of the event, and creating payloads of the second type corresponding to the event. The operations can further include performing type checking on event and corresponding payloads.

The declaration of the event can include an event name and payload type to be associated with the event. The event can include a first class communicating with a second class. In some implementations, performing type checking can include performing compile-time type checking In some implementations, performing type checking can include performing run-time type checking.

The operations can also include establishing a binding between an event type and a payload type. The events and payloads can be represented as strings.

### BRIEF DESCRIPTION OF THE DRAWINGS

FIG. 1 shows an example system for user interface frameworks in accordance with some implementations.

FIG. 2 is a flow chart for user interface frameworks in accordance with some implementations.

FIG. 3 is a flow chart showing an example method for user interface frameworks in accordance with some implementations.

FIG. 4 is a diagram fan example computing device configured for user interface frameworks in accordance with some implementations.

FIG. 5 shows a flow chart of an example method for event payload type checking in accordance with some implementations.

### DETAILED DESCRIPTION

Systems, methods and computer readable media for user interface frameworks and event payload type checking are disclosed. In general, in some implementations, the systems, methods and computer readable media can include a UI framework written in a language, such as Javascript or the like that compatible with web page mark-up languages such as hypertext mark-up language (HTML), extensible mark-up language (XML) or the like.

Some implementations can include a template-rendered UI in which the UI controllers are responsible for handling user interaction, while rendering is performed via templates. Also, the UI controllers can be configured to work with both server- and client-rendered HTML or other mark-up languages.

The UI framework can include controllers that are instantiated by declaring them in the template using a mark-up language or scripting language attribute such as a controller or the like. Interfaces connecting controllers can be declaratively specified as well.

Also, the UI controllers can be configured to handle asynchronous actions such as user events, late-loaded services, and server data requests. The framework can include a dependency-injection style of programming which permits a controller (or even a method of a controller) to specify what needs to happen before that controller is invoked. Thus, some of the complexities typically associated with asynchronous programming are absorbed into the framework.

UI controllers as described herein do not have to be initialized or even created in order to listen for events. A controller can be constructed automatically the first time an event is sent to it. Thus, the creation and/or initialization of a controller does not have to occur at page load time, allowing for a smaller initial download size as compared to some conventional UI frameworks. The UI framework as described herein may be particularly well suited to web applications having many complex pages that display large amounts of content.

The sometimes complex relationships between objects can be specified declaratively in the document object model (DOM) code rather than being constructed imperatively at application startup time. The setup phase for controllers can happen as needed and “just in time.”

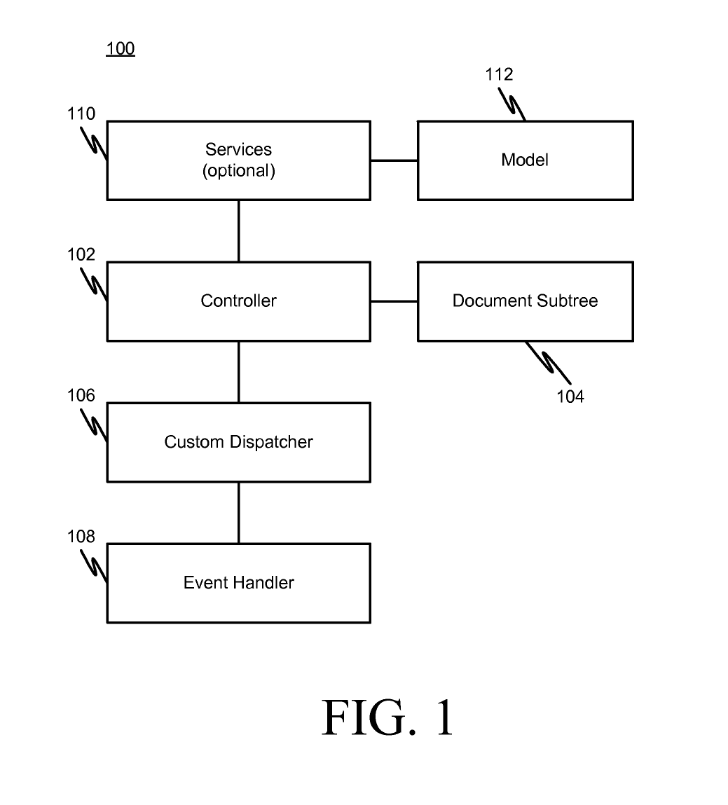

FIG. 1 shows an example system 100 for user interface frameworks having a controller 102 that manages a document subtree 104 (e.g., a subtree of a DOM), handles UI events and communicates with a data model 112 exposed through services 110. Alternatively, the controller 102 can communicate directly with the data model 112. Also, the data model 112 can manage the document subtree 104. The controller 102 and/or data model 112 can be implemented, for example, as a JavaScript object bound to an HTML subtree. Events that occur in the subtree may be handled by the controller 102, specified through an event handler 108 via HTML attributes. A custom dispatcher 106 maps event handlers (e.g., 108) to controllers (e.g., 102), manages their lifecycle and calls methods on them.

A simple example of an HTML fragment having a controller declaration is shown below for illustration purposes:

```
<div>
  <div controller=”foo. SampleController” data-userid=”1234”>
    <button action=”click:handleClick”>Click Me</button>
    <div jsname=”status”></div>
  </div>
</div>
```

An example of a JavaScript corresponding to the above HTML fragment is shown below:

foo.SampleController = framework.Controller( );
foo.SampleController.prototype.handleClick = function( ) {
this.element(‘status’).text(‘clicked’);
};

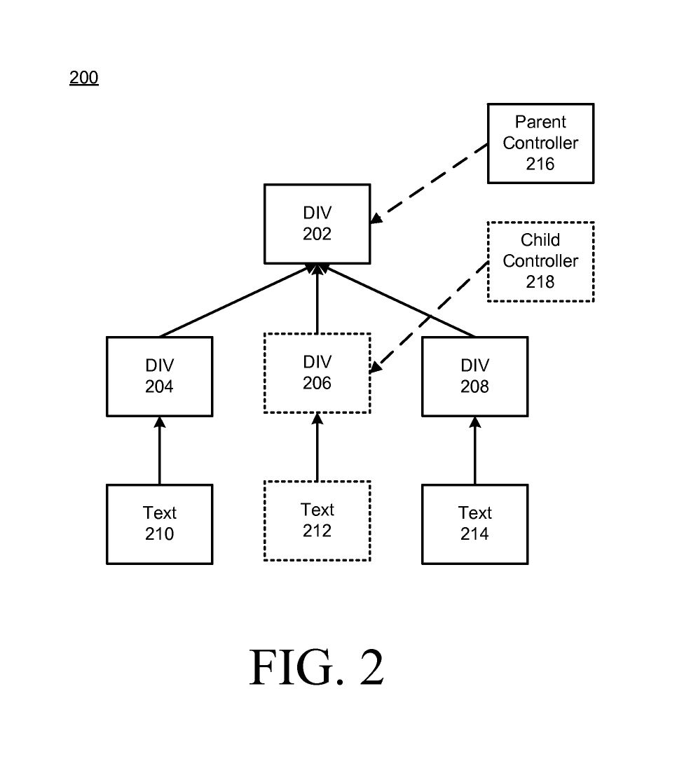

FIG. 2 shows a diagram of an example user interface framework environment 200 having a plurality of div elements, text elements and controllers. A parent controller 216 controls the subtrees for div 202, div 204 and div 208. A child controller 218 controls the DOM subtree of div 206.

The controllers (e.g., 216 and 218) are objects that manage subtrees of the DOM. The controller can be attached to a DOM element and is responsible for all the DOM nodes that are children of that element, except for portions that belong to a child controller.

Events that originate from within the DOM subtree may be handled by the controller. Events can be native browser events or application events coming from other controllers. When multiple controllers need to communicate and share data, the shared data can be placed into a separate model object, which each controller has a reference to. The model object can contain business logic and can communicate with the server.

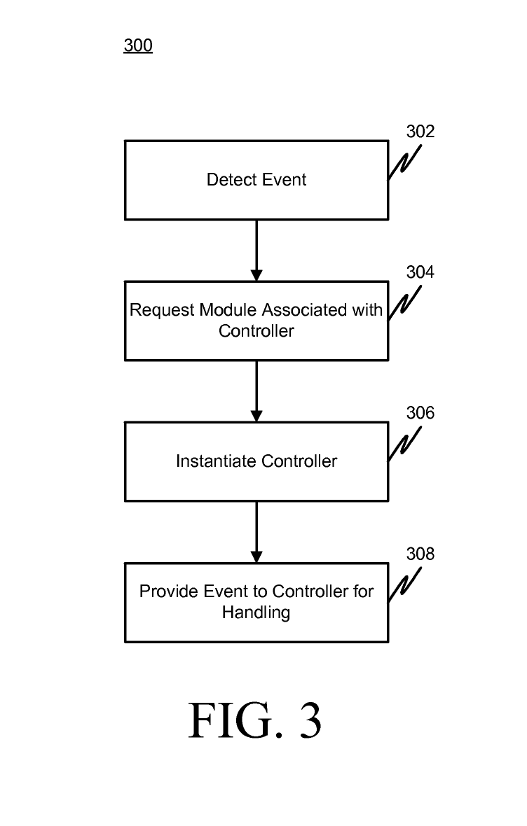

FIG. 3 is a flow chart showing an example method 300 for user interface frameworks in accordance with some implementations. Processing begins at 302, where an event is detected from within a DOM node associated with a controller (e.g., via the declaration technique discussed herein). Events can include an event from a user interface element or an event from another controller. Processing continues to 304.

At 304, a module associated with the controller is requested. The module may be requested just prior to passing the event to the controller. Processing continues to 306.

At 306, the controller is instantiated and initialized. Processing continues to 308.

At 308, the event is provided to the controller for handing. It will be appreciated that 302-308 can be repeated in whole or in part in order to accomplish a contemplated UI task.

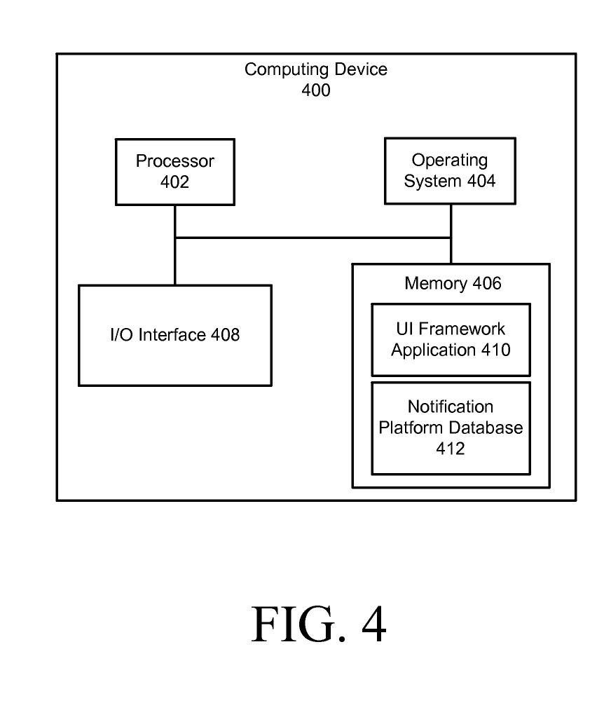

FIG. 4 is a diagram of an example computing device 400 that can be configured for providing and/or executing user interface frameworks in accordance with some implementations. The computing device 400 includes a processor 402, operating system 404, memory 406 and I/O interface 408. The memory 406 can include a user interface framework application 410 and a database 412 (e.g., for storing names of components, controllers, events, data models or the like).

In operation, the processor 402 may execute the user interface framework application 410 stored in the memory 406. The user interface framework application 410 can include software instructions that, when executed by the processor, cause the processor to perform operations for providing and/or executing a user interface framework in accordance with the present disclosure (e.g., the user interface framework application 410 can perform one or more of steps 302-308 described above and/or steps 502-510 described below and, in conjunction, can access the database 412). The user interface framework application 410 can also operate in conjunction with the operating system 404, and services, dispatchers, action handlers, events, document sub-trees and data models (as shown in FIG. 1).

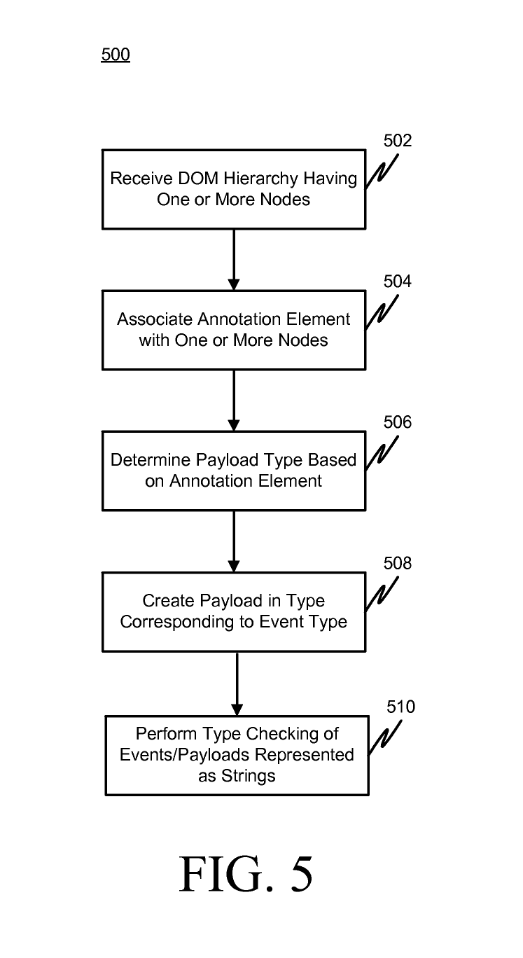

FIG. 5 shows a flow chart of an example method 500 for event payload type checking in accordance with some implementations. Processing begins at 502, where a document hierarchy (e.g., a DOM hierarchy) having one or more nodes is received. Processing continues to 504.

At 504, an annotation element is associated with one or more nodes. The annotation element can include a declaration of an event and type for that event. Processing continues to 506.

At 506, a payload type is determined based on the event declaration. Processing continues to 508.

At 508, payloads are created in a type that corresponds to the event type. Processing continues to 510.

At 510, type checking is performed on the events and payloads. The type checking can be performed at compile time and/or at run time. Any errors detected during type checking can be provided as output to a user or other system. It will be appreciated that 502-510 can be repeated in whole or in part in order to accomplish a contemplated payload type checking task.

The user interface framework computing device (e.g., 400) can include, but is not limited to, a single processor system, a multi-processor system (co-located or distributed), a cloud computing system, or a combination of the above.

The client (or user) device(s) can include, but are not limited to, a desktop computer, a laptop computer, a portable computer, a tablet computing device, a smartphone, a feature phone, a personal digital assistant, a media player, televisions, an electronic book reader, an entertainment system of a vehicle or the like. Also, client/user devices can include wearable computing devices (e.g., glasses, watches and the like), furniture mounted computing devices and/or building mounted computing devices.

The user devices can be connected to a user interface framework server via a network. The network connecting user devices to the user interface framework server can be a wired or wireless network, and can include, but is not limited to, a WiFi network, a local area network, a wide area network, the Internet, or a combination of the above.

The data storage, memory and/or computer readable medium can be a nontransitory medium such as a magnetic storage device (hard disk drive or the like), optical storage device (CD, DVD or the like), or electronic storage device (RAM, ROM, flash, or the like). The software instructions can also be contained in, and provided as, an electronic signal, for example in the form of software as a service (SaaS) delivered from a server (e.g., a distributed system and/or a cloud computing system).

Some implementations of the disclosed method, system, and computer readable media can be implemented in software (e.g., as a computer program product and/or nontransitory computer readable media having stored instructions user interface frameworks as described herein). The stored software instructions can be executed on a programmed general purpose computer, a special purpose computer, a microprocessor, or the like.

It is, therefore, apparent that there is provided, in accordance with the various example implementations disclosed herein, systems, methods and computer readable media for event payload type checking.

While the disclosed subject matter has been described in conjunction with a number of implementations, it is evident that many alternatives, modifications and variations would be or are apparent to those of ordinary skill in the applicable arts. Accordingly, Applicants intend to embrace all such alternatives, modifications, equivalents and variations that are within the spirit and scope of the disclosed subject matter.

What is claimed is:

1. A method comprising:
receiving a hierarchy of nodes;
associating an annotation element with one or more nodes, the annotation element corresponding to an event of a first type;
determining a second type based on a declaration of the event;
creating payloads of the second type corresponding to the event; and
performing type checking on event and corresponding payloads.

2. The method of claim 1, wherein the declaration of the event includes an event name and payload type to be associated with the event.

3. The method of claim 1, wherein the event includes a first class communicating with a second class.

4. The method of claim 1, wherein performing type checking includes performing compile-time type checking.

5. The method of claim 1, wherein performing type checking includes performing run-time type checking,

6. The method of claim 1, further comprising establishing a binding between an event type and a payload type.

7. The method of claim 1, wherein the events and payloads are represented as strings.

8. A system comprising:
one or more processors configured to perform operations including:
receiving a file having a hierarchy of nodes;
associating an annotation element with one or more nodes, the annotation element corresponding to an event of a first type;
determining a second type based on a declaration of the event;
creating payloads of the second type corresponding to the event; and
performing type checking on event and corresponding payloads.

9. The system of claim 8, wherein the declaration of the event includes an event name and payload type to be associated with the event.

10. The system of claim 8, wherein the event includes a first class communicating with a second class.

11. The system of claim 8, wherein performing type checking includes performing compile-time type checking.

12. The system of claim 8, wherein performing type checking includes performing run-time type checking.

13. The system of claim 8, wherein the operations further comprise establishing a binding between an event type and a payload type.

14. The system of claim 8, wherein the events and payloads are represented as strings.

15. A nontransitory computer readable medium having software instructions stored thereon that, when executed by a processor, cause the processor to perform operations comprising:
receiving a hierarchy of nodes;
associating an annotation element with one or more nodes, the annotation element corresponding to an event of a first type;
determining a second type based on a declaration of the event;
creating payloads of the second type corresponding to the event; and
performing type checking on event and corresponding payloads.

16. The nontransitory computer readable medium of claim 15, wherein the declaration of the event includes an event name and payload type to be associated with the event.

17. The nontransitory computer readable medium of claim 15, wherein the event includes a first class communicating with a second class.

18. The nontransitory computer readable medium of claim 15, wherein performing type checking includes performing compile-time type checking.

19. The nontransitory computer readable medium of claim 15, wherein performing type checking includes performing run-time type checking.

20. The nontransitory computer readable medium of claim 15, wherein the operations further comprise establishing a binding between an event type and a payload type, and wherein the events and payloads are represented as strings.
